(19) United States
(12) Patent Application Publication
(10) Pub. No.: US 2008/0240085 A1
(43) Pub. Date: Oct. 2, 2008

(54) SIP COMMUNICATION SYSTEM, CALL CONTROL SERVER AND CALL CONTROL METHOD

(76) Inventors: Yojiro Yoshizawa, Tokyo (JP); Minoru Ota, Tokyo (JP)

Correspondence Address: NEC CORPORATION OF AMERICA, 6535 N. STATE HWY 161, IRVING, TX, 75039, US

(21) Appl. No.: 12/049,712

(22) Filed: Mar. 17, 2008

(30) Foreign Application Priority Data
Mar. 27, 2007 (JP) 81419/2007

(51) Int. Cl. H04L 12/66

(52) U.S. Cl. 370/352

(57) ABSTRACT

There is provided a SIP communication system or the like which, by performing SIP communication between a terminal and a call control server via an access network configured on a different network infrastructure, performs position registration or calling control of the terminal, wherein, when position registration or calling control of the terminal is performed, a SIP message including an access type identifying the communication method used by the terminal on the access network or access information identifying position information about the position of the terminal in the access network as control information is transmitted and received between the terminal and the call control server.

This application is based upon and claims the benefit of priority from Japanese Patent Application No. 081419/2007, filed on Mar. 27, 2007, the disclosure of which is incorporated herein in its entirety by reference.

### BACKGROUND OF THE INVENTION

1. Field of the Invention

The present invention relates to a SIP communication system which, by performing SIP (Session Initiation Protocol) communication between a calling-side terminal and a call control server via an access network configured on a different network infrastructure, performs position registration and calling control of the terminal, the call control server, and the call control method.

2. Description of the Related Art

The VoIP (Voice over IP) service for performing voice communication on an IP (Internet Protocol) network has gathered attention because more inexpensive system construction is possible in comparison with the conventional public switched telephone network (PSTN) using a circuit switched network, from the viewpoint of operation, accounting and the like.

Furthermore, there have been proposed and developed techniques and standards for integrating mobile communication systems such as a mobile phone, and various communication networks such as a public wireless LAN (Local Area Network) and a public switched telephone networks, with a central focus on the VoIP technology to construct a next-generation network.

As an example of this kind of next-generation network architecture, for example, IMS (IP Multimedia Subsystem) by 3GPP (3rd Generation Partnership Project) is known (for example, 3GPP IP Multimedia Subsystem (IMS): http://www.3gpp.org/ftp/Specs/html-info/23228.htm).

Generally, in the VoIP communication system described above, when a call is made, a called terminal is identified by SIP between a calling terminal and a call control server to mediate connection between both terminals.

Though SIP techniques which are almost based on the specification proposed by RFC3261 and the like have been already put to practical use in each of current VoIP services, there is also proposed a configuration using a SIP message having a further extended header for a communication system considered to be a next-generation network, such as the IMS described above (for example, IMS call control protocol based on SIP and SDP: http://www.3gpp.org/ftp/Specs/html-info/24229.htm; and RFC3455 3GPP SIP extended header: http://www.ietf.org/rfc/rfc3455.txt).

In the above-described communication system considered to be a next-generation network, the call control server is required to process calls from calling terminals operating on various networks based on the IP technology, for example, access networks such as WLAN ((public) wireless LAN), WiMAX (Worldwide Interoperability for Microwave Access) and FTTH (Fiber To The Home: optical fiber communication network).

However, when accepting a call from a calling terminal on these different access networks, the call control server using the VoIP technology which has been conventionally proposed cannot perform optimum call control suitable for the characteristics of the network constituting the calling-side access network and of the calling terminal.

For example, it is anticipated that the networks used as the access networks described above differ in the communication speed and the response speed between terminals, and it is further conceivable that the processing power of the calling terminal itself differs according to the product specification of the model.

### SUMMARY OF THE INVENTION

An exemplary object of the invention is to make it possible to perform optimum call control suitable for the characteristics of the network constituting a calling-side access network and of a calling terminal by a call control server which performs calling control, and thereby make it possible to perform efficient and highly reliable communication.

An exemplary aspect of the invention includes a SIP communication system which, by performing SIP communication between a terminal and a call control server via an access network configured on a different network infrastructure, performs position registration or calling control of the terminal, the call control server and a call control method, wherein, when position registration or calling control of the terminal is performed, a SIP message including an access type identifying the communication method used by the terminal on the access network or access information identifying position information about the position of the terminal in the access network as control information is transmitted and received between the terminal and the call control server; and the call control server refers to a position information table storing setting information selecting optimum communication control for a terminal or its access network identified by the access type or the access information, with the use of the access type or the access information, to determine the form of communication control to be performed for the terminal or its access network.

According to the above configuration, the call control server can determine the form of communication control to be performed for a terminal or its access network with the use of the access type or the access information. Thereby, optimum communication control suitable for the characteristics of the network constituting a calling-side access network or of a calling terminal can be performed by the call control server, and an excellent advantage is obtained that efficient and highly reliable communication can be performed.

### BRIEF DESCRIPTION OF THE DRAWINGS

FIG. 1 is a diagram showing the functional block configuration of a call control server adopting an exemplary embodiment of the present invention;

FIG. 2 is a diagram showing the state of a SIP sequence executed between the call control server adopting the exemplary embodiment of the present invention and a terminal;

FIG. 3 is a flowchart showing the state of control performed by the call control server adopting the exemplary embodiment of the present invention, when the call control server receives a request message;

FIG. 4 is a diagram showing the configuration of a position information table used by the call control server adopting the exemplary embodiment of the present invention;

FIG. 5 is a diagram showing the configuration of a SIP communication system constituted by the call control server adopting the exemplary embodiment of the present invention and a terminal; and

FIG. 6 is a block diagram showing the configuration of the control system of the call control server adopting the exemplary embodiment of the present invention.

### DETAILED DESCRIPTION OF THE EXEMPLARY EMBODIMENT

Now, description will be made on a VoIP communication system constructed with a central focus on a call control server for processing calls from different access networks configured on various network infrastructures, as an exemplary embodiment of the present invention, with reference to drawings.

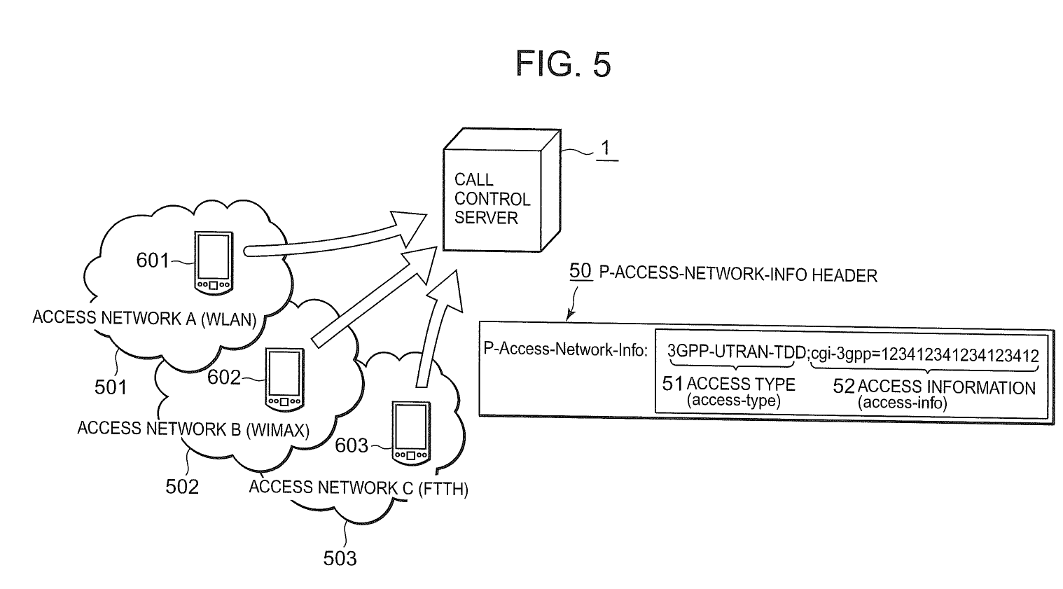

FIG. 5 shows the outline of the configuration of a VoIP communication system adopting the present invention.

In FIG. 5, reference numeral 1 denotes a call control server. This call control server 1 accepts VoIP calls from terminals 601, 602, 603, . . . via different access networks (A, B, C, . . . ) 501, 502, 503, . . . constructed on various network infrastructures such as WLAN ((public) wireless LAN), WiMAX (Worldwide Interoperability for Microwave Access) and FTTH (Fiber To The Home: optical fiber communication network).

The call control server 1 is installed on an IP network (for example, the Internet) by a carrier or the like. It is assumed that each of the access networks 501, 502, 503, . . . can mutually connected with the IP network on which the call control server 1 is installed via IP-based communication, for example, via communication using protocols such as TCP, UDP and RTP.

The call control server 1 processes calls from the terminals 601, 602, 603, . . . which perform communication using the access networks 501, 502, 503, . . . , respectively. This calling processing is controlled by SIP. In this embodiment, it is assumed that the extended SIP protocol shown in Non-patent Documents 2 and 3 described above is used as the SIP protocol.

The respective calling terminals 601, 602, 603, . . . of the access networks 501, 502, 503, . . . exchange SIP messages with the call control server 1 when making a call. This SIP message is given a P-Access-Network-Info header 50 shown as shown at the lower right of the figure as control information.

This P-Access-Network-Info header 50 is used in the above-described extended SIP, and it includes an access type (access-type) 51 and access information (access-info) 52 as control information.

The access type (access-type) 51 identifies network layer techniques for the layers 2 and 3 (communication methods) to be used by the terminal on the access network. In the example shown in the figure, the access type is “3GPP-UTRAN-TDD”. In addition, information such as “IEEE-802.11a/b”, “3GPP-GERAN”, “3GPP-UTRAN-FDD”, “3GPP-UTRAN-TDD”, and “3GPP-CDMA2000” is stored as the access type (access-type) 51 according to the layer 2 and layer 3 techniques used by the terminal and its access network.

The access information (access-info) 52 is information about a cell on the access network to which the terminal connects, that is, information identifying the position of the terminal within the access network. A cell information code is stored in the form of “cgi-3gpp=xxxxxxxxxx . . . ” as shown in the figure on the basis of the current position of the terminal on the access network.

In this embodiment, when performing position registration or making a call, a calling terminal (601, 602, 603, . . . ) transmits a SIP message attached with the P-Access-Network-Info header 50 as described above, to the call control server 1. Then, the call control server 1 selects optimum settings for calling control in consideration of the characteristics of the terminal or the characteristics of the access network to which the terminal belongs, with the use of the information of the access type (access-type) 51 and the access information (access-info) 52 of the P-Access-Network-Info header 50.

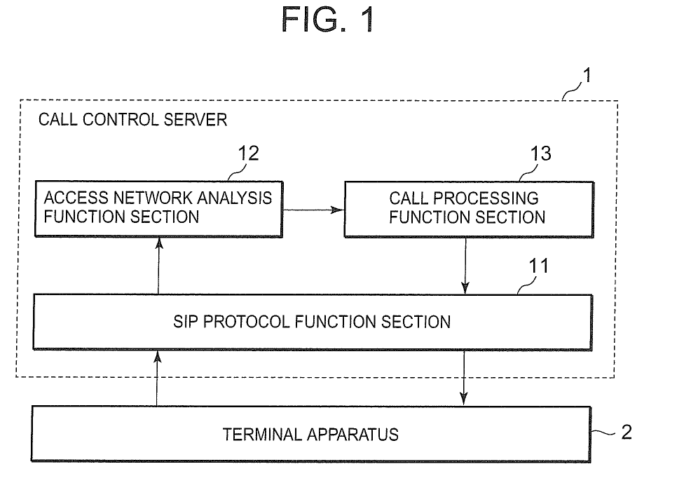

FIG. 1 shows the outline of the functional configuration of the call control server 1 described above.

In FIG. 1, the call control server 1 is configured by a SIP protocol function section 11, an access network analysis function section 12 and a call processing function section 13. The function sections 11 to 13 are configured by the hardware of the call control server 1 and software.

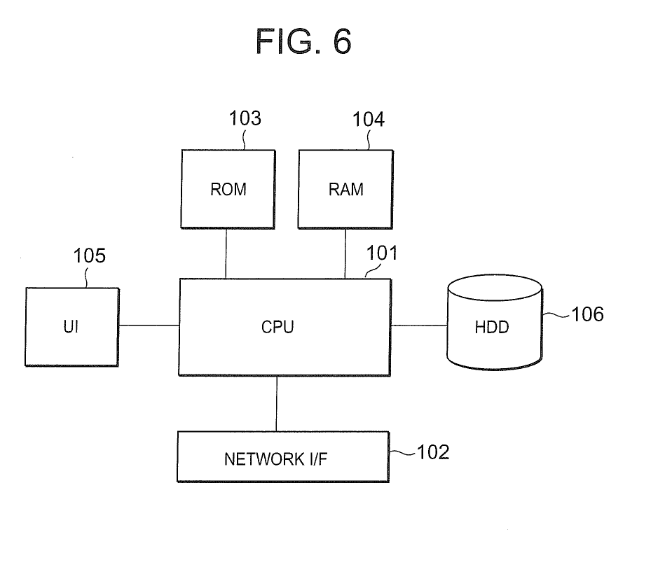

The hardware of the call control server 1 is configured, for example, as shown in FIG. 6.

In FIG. 6, the call control server 1 is constituted by a CPU 101 as main control means, a network interface 102 used as an interface with an IP network on which the call control server 1 is arranged, a ROM 103 in which control programs of the CPU 101 and constants required for control are stored, a RAM 104 used as a work area, user interface means 105 configured by a keyboard, a display and the like used for setting, management and maintenance of the apparatus.

The call control server 1 may be also provided with an HDD 106 for storing database information required for call control as necessary.

In FIG. 1 again, the function sections 11 to 13 of the call control server 1 are actually control means realized by the CPU 101 in FIG. 6 controlling each hardware in the figure in accordance with a control procedure to be described later. The control procedure described later is stored in the ROM 103 (or the HDD 106 or the like) as the control program of the CPU 101.

The SIP protocol function section 11 in FIG. 1 has a function of transmitting and receiving a SIP message between a calling terminal and a called terminal in accordance with the SIP protocol.

The access network analysis function section 12 constitutes a main part of the present invention. At the time of accepting position registration of a terminal or a call from a terminal, it analyzes the P-Access-Network-Info header 50 in a SIP message transmitted by the terminal. After that, on the basis of the analysis result, the setting operation by the call control server 1 is performed so that optimum call control suitable for the characteristics of the network constituting the calling-side access network and of the calling terminal can be performed.

The call processing function section 13 transmits a SIP response message to a terminal 2 (corresponding to the terminals 601, 602, 603, . . . in FIG. 5) via the control by the SIP protocol function section 11, on the basis of the result of the analysis by the access network analysis function section 12.

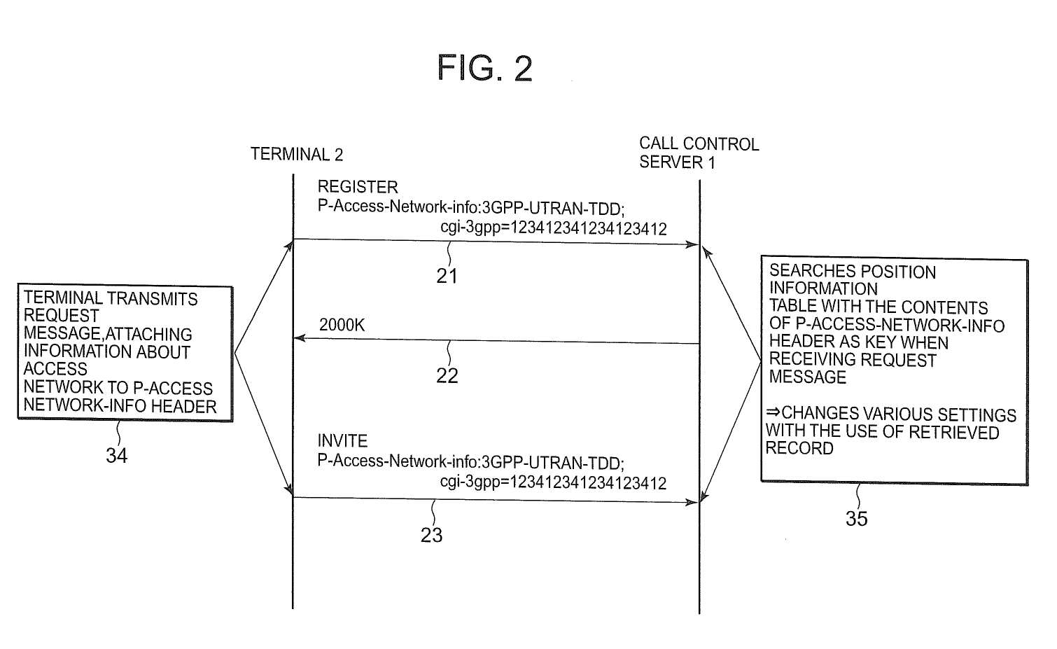

Next, the operation performed in the above configuration will be described with reference to FIGS. 2 to 4.

FIG. 2 shows a typical SIP sequence in which the communication control of the present invention is performed. The SIP sequence in FIG. 2 is executed between the terminal 2 and the call control server 1.

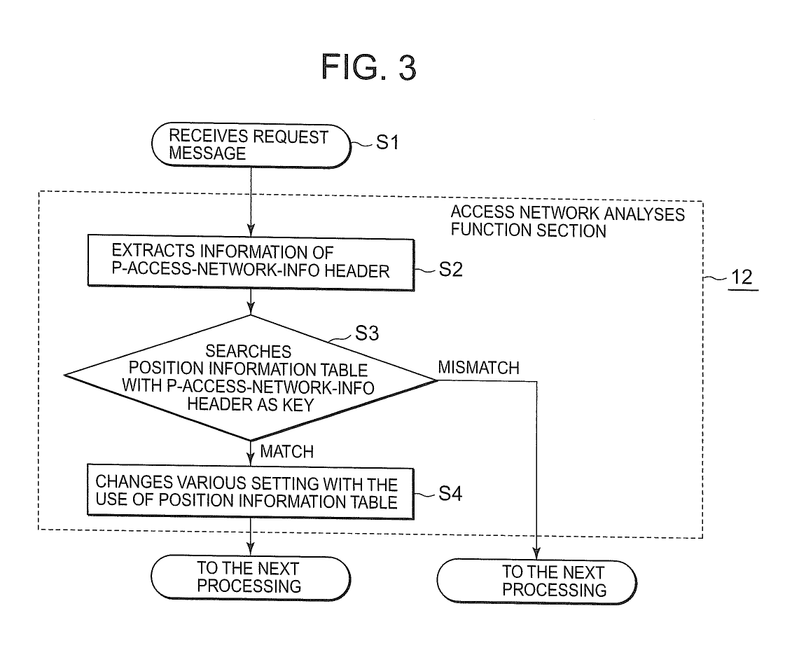

FIG. 3 shows the flow of a control procedure constituting the main part of the access network analysis function section 12 described above. The control procedure shown in the figure is stored, for example, in the ROM 103 (or the HDD 106 or the like) as the control program of the CPU 101 of the call control server 1.

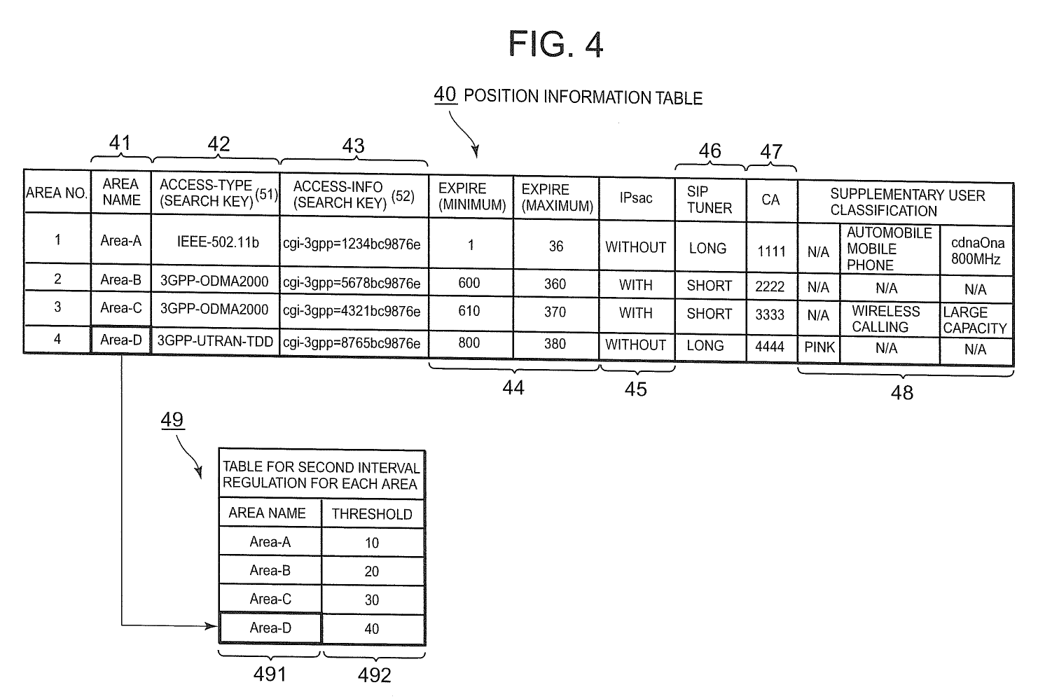

FIG. 4 shows a configuration example of a position information table to be referred to in the sequence in FIG. 2 or in the control procedure in FIG. 3.

First, FIG. 2 will be described. FIG. 2 shows a typical SIP sequence performed when the terminal 2 registers its position or makes a call. In the figure, when the terminal 2 is within a particular service area of the access network to which it belongs to, it transmits a REGISTER message 21 for registering which cell it stays in, to the call control server 1.

In response to this REGISTER message 21, the call control server 1 transmits an OK message 22 (the message identification code is “200”) if it permits the position registration, after referring to subscriber information and the like stored in the HDD 106 or the like.

When calling a desired destination station, the terminal 2 transmits an INVITE message 23 to the call control server 1.

Receiving the INVITE message 23, the call control server 1 extracts identification information about the destination station concerned from a part of the INVITE message 23 which is not shown in the figure. This identification information is described in the form of a pseudo URL or URI which is generated, for example, by re-arranging a telephone number in the opposite direction. The call control server 1 refers to an ENUM server or a domain name server not shown in the figure when necessary to identify the IP address of the destination station. After that, the call control server 1 mediates the initial phase of VoIP communication (or other data communication, image communication or the like that is possible in the IMS) between the destination station specified by the identified IP address and the calling-side terminal 2. Since the communication operation itself which is performed after receiving the INVITE message 23 is well known, further detailed description thereof will be omitted here.

In FIG. 2, when transmitting the REGISTER message 21 and the INVITE message 23, the terminal 2 transmits them by attaching the P-Access-Network-Info header 50 described above in accordance with the standard described above (34). As shown in FIG. 5, the P-Access-Network-Info header 50 includes the information of the access type (access-type) 51 and the access information (access-info) 52.

In this embodiment, the call control server 1 searches a position information table 40 in FIG. 4 using the information of the access type (access-type) 51 and the access information (access-info) 52 received by the P-Access-Network-Info header 50 of the REGISTER message 21 and the INVITE message 23 (the same for other SIP messages) as keys. Then, using a record retrieved from the position information table 40, the call control server 1 changes various settings made for itself with the optimum conditions for the characteristics of the terminal 2 and the access network to which the terminal 2 belongs to (35).

FIG. 3 shows that the call control server 1 refers to the position information table 40 using the information of the P-Access-Network-Info header 50 which it has received and changes the settings made for itself.

At step S1 in FIG. 3, when the call control server 1 receives a request message (the REGISTER message 21, the INVITE message 23 or other SIP messages) from the terminal 2, a routine constituting the access network analysis function section 12 of the call control server 1 is activated.

First, at step S2, each information of the P-Access-Network-Info header 50 is extracted from the received request message.

Next, at step S3, the position information table 40 is searched on the basis of the information of the P-Access-Network-Info header 50.

If a record having matched keys is retrieved by this search, then, at step S4, the call processing function section 13 is controlled to change various settings for the terminal 2 which has sent the request message, with the use of the registered information in the record in the position information table 40. If a record having matched keys is not retrieved at step S3, then the call control server 1 ends the processing by the access network analysis function section 12 and executes different processing.

As described above, with the use of the information stored in a SIP message transmitted from the terminal 2 (corresponding to the terminals 601, 602, 603, . . . in FIG. 5), especially with the use of the information of the P-Access-Network-Info header 50, the call control server 1 can change the various settings made for the terminal 2.

Here, description will be made on an example of various setting processings performed by the access network analysis function section 12 of the call control server 1 for the call processing function section 13, with reference to FIG. 4.

In this position information table 40, there is stored, with the access type (access-type) and the access information (access-info) as key information, setting information for setting the call control server 1, especially its call processing function section 13 so that optimum communication control for a terminal or its access network identified by the key information can be selected.

The position information table 40 is stored in storage means such as the HDD 106 of the call control server 1.

In the position information table 40 in FIG. 4, reference numerals 42 and 43 denote fields for storing the access type (access-type) and the access information (access-info) corresponding to reference numerals 51 and 52 described above, respectively.

In the position information table 40, various setting information 44 to 48 which can be classified by the information of the access type (access-type) 42 and the access information (access-info) 43 are categorized with the use of area names 41 and stored, as shown in the figure.

In the field 44 among the setting information 44 to 48, the minimum time and the maximum time of Expire (expiration of period) of position registration (REGISTER) appropriate for the terminal (601, 602, 603, . . . in FIG. 5) or the access network (501, 502, 503, . . . in FIG. 5) are stored. Therefore, by referring to the fields for the access type (access-type) 42 and the access information (access-info) 43, reading a set value from the field 44 of a corresponding record, and setting the value for the call processing function section 13, it is possible to determine an optimum position registration (REGISTER) period suitable for the characteristics of the terminal or of the access network (501, 502, 503, . . . in FIG. 5) to which the terminal belongs.

In the field 45, setting information about so-called VoIP over IPsec, that is, setting information about whether VoIP communication is to be performed via a communication channel encrypted by IPsec (IP Security) is stored. Therefore, by referring to the fields for the access type (access-type) 42 and the access information (access-info) 43, reading information in the field 45 of a corresponding record, and setting the information for the call processing function section 13, it is possible to determine whether or not to perform VoIP over IPsec communication on the basis of the characteristics of the terminal or of the access network (501, 502, 503, . . . in FIG. 5) to which the terminal belongs. Thus, for example, by specifying setting information in the field 45 on the basis of whether the terminal concerned or its access network uses a firewall or a router which performs address conversion such as NAT/NAPT, it is possible to, as for IPsec communication, automatically select optimum setting suitable for the terminal or the access network.

Similarly, in the fields 46, 47 and 48, there is stored various setting information suitable for the terminal and its access network which can be categorized by the access type (access-type) 42 and the access information (access-info) 43. The field 46 among the fields stores information indicating whether the length of the SIP timer is long or short, the field 47 stores CA (charge area information), and the field 48 stores supplementary user classification information.

The field 46 stores a set value of a SIP retransmission timer (two values of “long” and “short” here). Therefore, by referring to the fields for the access type (access-type) 42 and the access information (access-info) 43, reading the set value of the SIP retransmission timer from the field 46 of a corresponding record, and setting the set value for the call processing function section 13, it is possible to make optimum SIP retransmission time setting suitable for the characteristics of the terminal (601, 602, 603, . . . in FIG. 5) or the access network (501, 502, 503, . . . in FIG. 5) to which the terminal belongs.

The CA (charge area information) in the field 47 can be used to control accounting corresponding to the terminal or the access network. The field 48 for supplementary user classification information can be used to store information about the specifications, characteristics and performance of equipment peculiar to the terminal or the access network as shown in the figure, and further necessary control can be performed depending on the specifications, characteristics and performance of the equipment.

It is also possible to refer to a different setting information table from any storage field in the position information table 40 to further perform different control. In the example in FIG. 4, a table for second interval regulation for each area 49 can be referred to from the information stored in the field 41 for area name.

In the table for second interval regulation for each area 49, there is stored a threshold for determining the incoming call regulation level for each area configured by each corresponding access network (501, 502, 503, . . . in FIG. 1) as shown in the figure. Therefore, if each corresponding access network (501, 502, 503, . . . in FIG. 1) can be identified from the access type (access-type) 42 and the access information (access-info) 43, an optimum second regulation (outgoing call regulation) suitable for the characteristics of each access network can be selected.

Though an example of referring to the table for second interval regulation for each area 49 from the storage field 41 in the position information table 40 is shown here, it is possible to refer to a table storing any other setting information to control the settings of the call processing function section 13 to be optimum settings as necessary.

As described above, according to the exemplary embodiment of the present invention, the call control server 1 can change various settings made for the terminal 2 and determine the form of communication control to be performed for the terminal or its access network with the use of information stored in a SIP message transmitted from the terminal, especially the information of the P-Access-Network-Info header. Thereby, optimum communication control suitable for the characteristics of the network constituting a calling-side access network or of a calling terminal can be performed by the call control server 1, and an excellent advantage is obtained that efficient and highly reliable VoIP communication can be performed.

Though a configuration example has been shown in which a position information table is searched with the use of the access type (access-type) and the access information (access-info) used in the extended SIP as keys, it is not necessarily required to use both of them. That is, it is also possible to search the position information table with the use of only one of the access type and the access information and change setting information for controlling the operation of a call control server on the basis of control information read from each field in the position information table.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A SIP communication system which, by performing SIP communication between a terminal and a call control server via an access network configured on a different network infrastructure, performs position registration or calling control of the terminal, wherein
when position registration or calling control of the terminal is performed, a SIP message including an access type identifying the communication method used by the terminal on the access network or access information identifying position information about the position of the terminal in the access network as control information is transmitted and received between the terminal and the call control server; and
the call control server refers to a position information table storing setting information selecting optimum communication control for a terminal or its access network identified by the access type or the access information, with the use of the access type or the access information, to determine the form of communication control to be performed for the terminal or its access network.

2. The SIP communication system according to claim 1, wherein a position registration period suitable for the terminal or its access network identified by the access type or the access information is determined with the use of the access type or the access information.

3. The SIP communication system according to claim 1, wherein it is determined whether or not to perform encryption communication for the terminal or its access network identified by the access type or the access information, with the use of the access type or the access information.

4. The SIP communication system according to claim 1, wherein the set time of a SIP retransmission timer suitable for the terminal or its access network identified by the access type or the access information is determined with the use of the access type or the access information.

5. The SIP communication system according to claim 1, wherein the incoming call regulation level for each area of the access network identified by the access type or the access information is determined with the use of the access type or the access information.

6. A call control server which, by performing SIP communication with a terminal connecting to the call control server via an access network configured on a different network infrastructure, performs position registration or calling control of the terminal, the call control server comprising:
a SIP protocol function section for, when position registration or calling control of the terminal is performed, receiving a SIP message including an access type identifying the communication method used by the terminal on the access network or access information identifying position information about the position of the terminal in the access network as control information, from the terminal;
a position information table storing setting information selecting optimum communication control for a terminal or its access network identified by the access type or the access information; and
controller to refer to the position information table with the access type or the access information of the SIP message received by the SIP protocol function section to determine the form of communication control to be performed for the terminal or its access network.

7. The call control server according to claim 6, wherein a position registration period suitable for the terminal or its access network identified by the access type or the access information is determined with the use of the access type or the access information.

8. The call control server according to claim 6, wherein it is determined whether or not to perform encryption communication for the terminal or its access network identified by the access type or the access information, with the use of the access type or the access information.

9. The call control server according to claim 6, wherein the set time of a SIP retransmission timer suitable for the terminal or its access network identified by the access type or the access information is determined with the use of the access type or the access information.

10. The call control server according to claim 6, wherein the incoming call regulation level for each area of the access network identified by the access type or the access information is determined with the use of the access type or the access information.

11. A call control method for, by performing SIP communication between a terminal and a call control server via an access network configured on a different network infrastructure, performing position registration or calling control of the terminal, wherein when position registration or calling control of the terminal is performed, a SIP message including an access type identifying the communication method used by the terminal on the access network or access information identifying position information about the position of the terminal in the access network as control information is transmitted and received between the terminal and the call control server; and
the call control server refers to a position information table storing setting information selecting optimum communication control for a terminal or its access network identified by the access type or the access information, with the use of the access type or the access information, to determine the form of communication control to be performed for the terminal or its access network.

12. The call control method according to claim 11, wherein a position registration period suitable for the terminal or its access network identified by the access type or the access information is determined with the use of the access type or the access information.

13. The call control method according to claim 11, wherein it is determined whether or not to perform encryption communication for the terminal or its access network identified by the access type or the access information, with the use of the access type or the access information.

14. The call control method according to claim 11, wherein the set time of a SIP retransmission timer suitable for the terminal or its access network identified by the access type or the access information is determined with the use of the access type or the access information.

15. The call control method according to claim 11, wherein the incoming call regulation level for each area of the access network identified by the access type or the access information is determined with the use of the access type or the access information.
